(19) United States
(12) Patent Application Publication
(10) Pub. No.: US 2011/0012548 A1
(43) Pub. Date: Jan. 20, 2011

(54) Safty system for electric ride-on toys

(76) Inventors: Julia Marie Wilcox, Bonita Springs, FL (US); Stacy Anne Wilder, Ft. Myers, FL (US)

Correspondence Address: George F. Wallace, 2010 Willow Branch Drive, Cape Coral, FL, 33991, US

(21) Appl. No.: 12/460,125

(22) Filed: Jul. 14, 2009

(51) Int. Cl. B60L 3/04; H02P 3/00

(52) U.S. Cl. 318/468; 180/65.8

(57) ABSTRACT

A safety system for an electric ride-on toy includes a current regulator electrically connected between the battery and electric motor; and a control module connected to the current regulator, having an input device adapted to receive a safety command, and adapted to activate the current regulator if the safety command is received. When activated, the current regulator reduces the electrical current provided from the battery to the electric motor. Current reduction can be in whole or in part. The control module can include a variable resistor. The safety system can optionally include a reset mechanism. When activated, the current regulator remains activated until the reset mechanism is triggered. The input device can be a wireless receiver, and the safety system can further include a wireless transmitter for sending the safety command and/or a warning signal. The wireless transmitter can include an antennae positioned to form a boundary, which can be open or closed.

### FIELD OF THE INVENTION

The present invention relates to electric ride-on toys, and more specifically, to safety systems for electric ride-on toys.

### BACKGROUND OF THE INVENTION

Electric ride-on toys are designed to be ridden by children, who control the movement of the same. These toys include an electric motor, and for some, a steering device (e.g., a steering wheel, for example), which cooperatively move the vehicle from a starting position.

### BRIEF SUMMARY OF THE INVENTION

It is, therefore, an object of the present invention to provide a safety system for electric ride-on toys.

In an exemplary embodiment, the present invention can be embodied in a safety system for an electric ride-on toy having an electric motor electrically connected to a battery providing electrical current to the electric motor, and an accelerator device electrically connected between the electric motor and the battery, the accelerator device being adapted to deliver the electrical current from the battery to the electric motor. The safety system can include a current regulator adapted to electrically connect between the battery and the electric motor; and a control module, connected to said current regulator, and having an input device adapted to receive a safety command, said control module being adapted to activate said current regulator if the safety command is received by the input device. The control module activates said current regulator when the input device receives the safety command, and when activated, the current regulator reduces the electrical current provided from the accelerator device to the electric motor.

In another exemplary aspect of the invention, the control module can include a variable resistor, and when activated, the current regulator reduces the electrical current in part.

In a further exemplary aspect of the invention, when activated, the current regulator reduces the electrical current in total.

According to another exemplary aspect of the present invention, a safety system can further include a reset mechanism; where upon activation, the current regulator remains activated until the reset mechanism is triggered.

In still yet another exemplary aspect of the invention, the input device can include a wireless receiver, and the safety system can further include a wireless transmitter adapted to send the safety command to the control module via the wireless receiver.

In still yet a further exemplary aspect of the invention, the wireless transmitter can include an antennae positioned to form a boundary, and can transmit the safety signal along the boundary at a particular strength such that the wireless receiver receives the safety signal when the wireless receiver is within a particular distance from the boundary.

In another exemplary aspect of the present invention, the antennae can be positioned to form an enclosed area.

In another exemplary embodiment, the present invention can be embodied in a safety system for an electric ride-on toy having an electric motor electrically connected to a battery providing electrical current to the electric motor, and an accelerator device electrically connected between the electric motor and the battery, the accelerator device being adapted to deliver the electrical current from the battery to the electric motor. The safety system can include a current regulator adapted to electrically connect the accelerator device to the electric motor, where the current regulator reduces the electrical current provided from the accelerator device to the electric motor.

### BRIEF DESCRIPTION OF THE DRAWINGS

The present invention is illustrated by way of example, and not in limitation, in the figures of the accompanying drawings, in which:

FIG. 1 illustrates an exemplary environment of the present invention, in which an electric ride-on toy (not shown) includes an electric motor, a battery, and an accelerator device.

FIG. 2a illustrates an exemplary safety system according to the present invention, in which a current regulator is electrically connected between an accelerator device and a battery.

FIG. 2b illustrates an exemplary safety system according to the present invention, in which a current regulator is electrically connected between an electric motor and an accelerator device.

FIG. 3 illustrates another exemplary safety system according to the present invention, which includes a wireless receiver and a wireless transmitter.

FIG. 4 illustrates another exemplary safety system according to the present invention, which includes a wireless transmitter is a remote control.

FIG. 5 illustrates another exemplary safety system according to the present invention, in which a wireless receiver includes an antennae positioned to form a boundary.

FIG. 6 illustrates another exemplary safety system according to the present invention, in which an antennae is positioned to form a closed boundary.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular physical configuration, shape, size, or order.

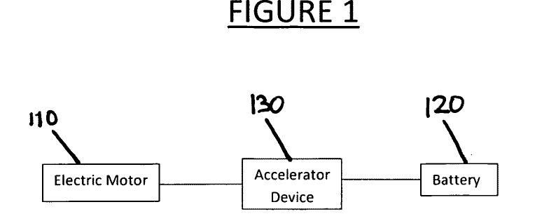

FIG. 1 contextually illustrates an exemplary environment of the present invention, in which an electric ride-on toy (not shown) includes an electric motor 110 electrically connected to a battery 120 that provides electrical current to the electric motor, and an accelerator device 130 electrically connected between the electric motor and the battery. Electric motor 110 propels the ride-on toy by mechanically moving one or more motion elements (not shown), which can be one or more wheels and/or propellers, for example and not in limitation. Battery 120 provides a particular voltage, such as twelve (12) volts, for example and not in limitation, and can include a series of batteries (for description purposes labeled as “battery” and illustrated singularly). Accelerator device 130 is adapted to selectively deliver the electrical current from the battery to the electric motor, and can be embodied in any desired form, such as a throttle, pedal, and/or switch, for example and not in limitation. Selective delivery can include on/off, stop/go, and/or plural levels and/or polarities of electrical delivery (e.g., off, low, medium, high, reverse, etc., for example and not in limitation).

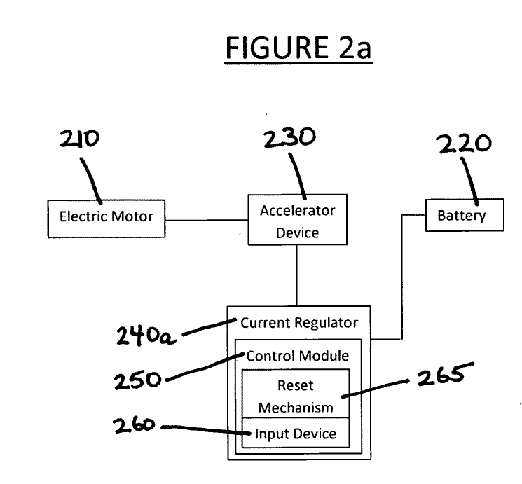

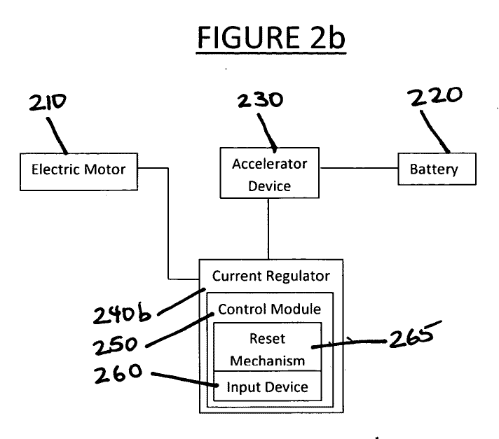

FIGS. 2a and 2b illustrate exemplary safety systems according to the present invention, in which a current regulator 240a/240b is electrically connected between electric motor 210 and battery 220, with accelerator device 230 electrically connected between electric motor 210 and battery 220. As further illustrated, current regulator 240a/240b is also electrically connected between electric motor 210 and battery 220. As illustrated, current regulator 240a can be connected between battery 220 and accelerator device 230, or regulator 240b can be connected between accelerator device 230 and electric motor 210, for example and not in limitation.

As also illustrated, current regulator 240a/240b include control module 250, which includes input device 260 that is adapted to receive a safety command. According to an exemplary aspect of the present invention, a safety command can include an electrical (e.g., wireless, wired, for example, and not in limitation) or mechanical signal (e.g., the operation of a switch, dial, button, or other mechanical mechanism, for example and not in limitation). Accordingly, a safety signal can be provided manually (e.g., by hand, for example and in not in limitation) or electronically (e.g., transmitter boundary, remote control, etc., for example and not in limitation). Upon receipt of a safety command by input device 260, control module 250 is adapted to activate current regulator 240. According to an exemplary aspect of the invention, when activated, current regulator 240 functionally acts, and therefore is, an electrical resistor that reduces the amount of current that travels across it, and therefore, reduces the amount of current passing from battery 220 to electric motor 210. According to the present invention, current regulator 240 can reduce the amount of current flowing across it in total or in part. For example, when reducing the current in total, current regulator 240 functions as a “kill switch,” rendering the ride-on toy inoperable in terms of motion; while when reducing the current in part, current regulator 240, which can be a variable or static resistor, can reduce the maximum current flowing across it, which reduces the maximum speed of the ride-on toy. Thus, as can be seen, the present invention effectively reduces the voltage provided by battery 220, through accelerator device 230, which reaches electric motor 210. As further illustrated, any safety system according to the present invention (whether wired, wireless, or otherwise) can optionally include a reset mechanism 255, which resets the safety system after activation, either automatically (after a period of time has expired) or manually (upon manual triggering of reset mechanism 255).

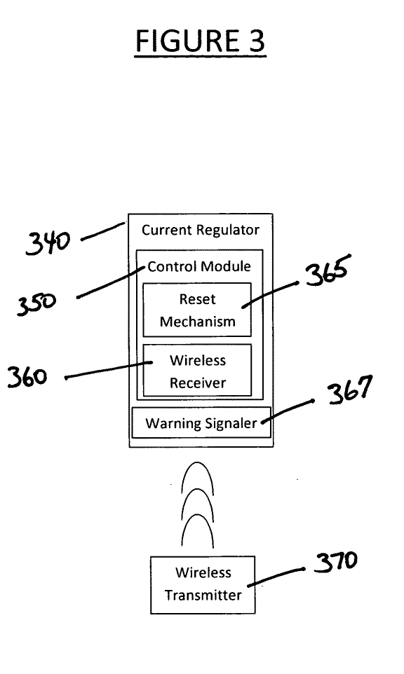

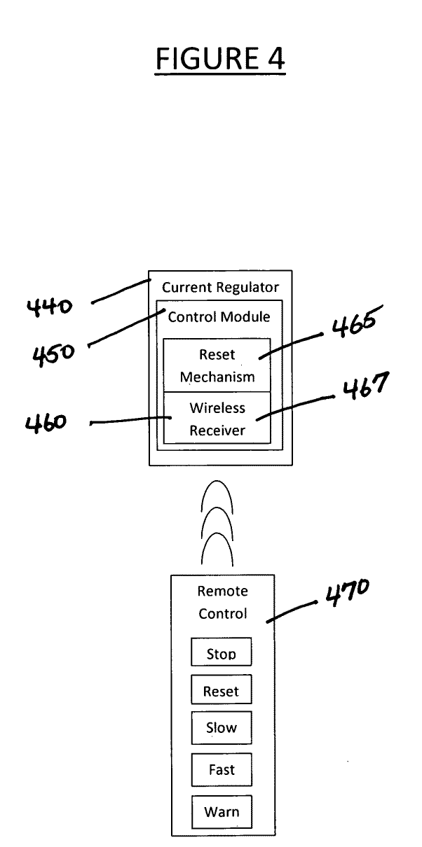

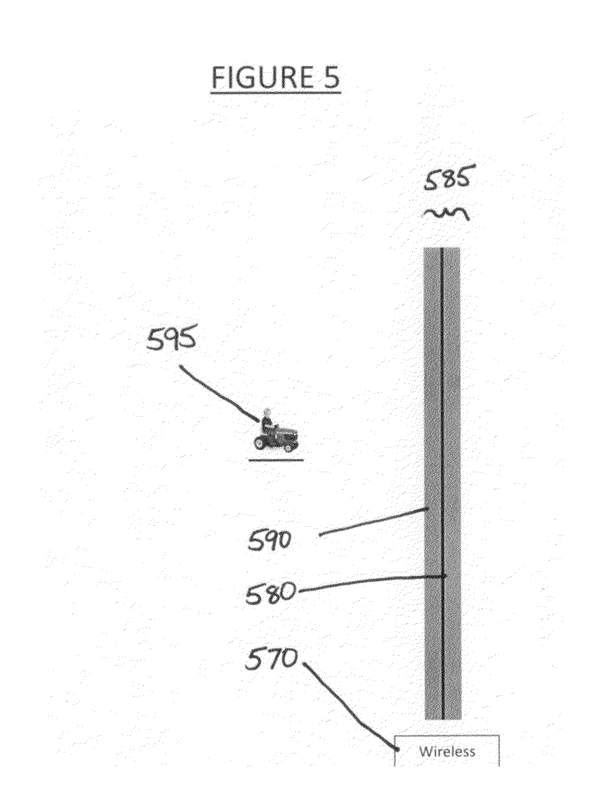

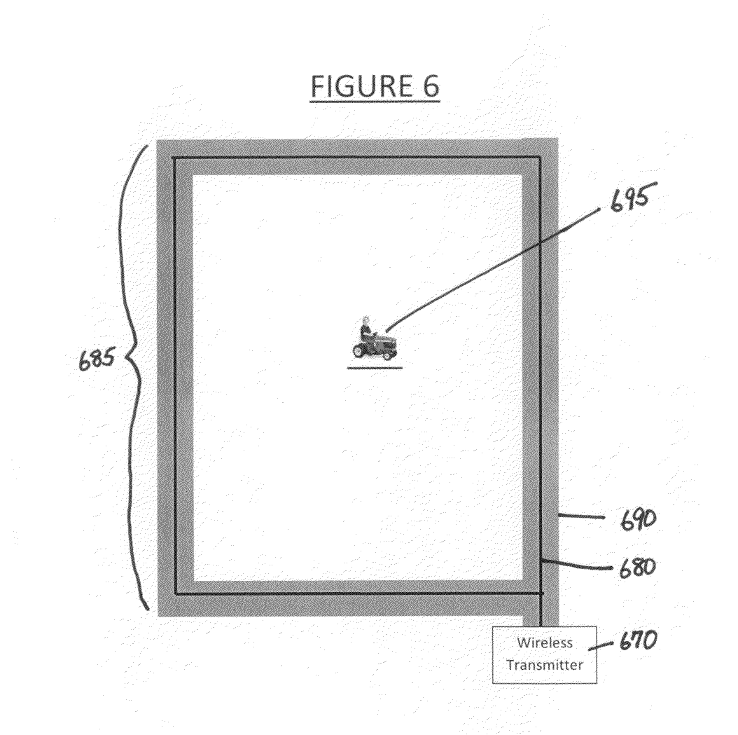

Reference is now made to FIG. 3, which illustrates another exemplary embodiment of the present invention, in which the input device can be a wireless receiver 360, which is adapted to receive a wireless safety signal from wireless transmitter 370. As illustrated, wireless transmitter 370 can be utilized to wirelessly send the safety signal to wireless receiver 360. As also illustrated, a safety system can include an optional warning signaler 367, which can be in the form of a light and/or speaker, for example and not in limitation to provide an visual and/or audible signal. Warning signaler 367 can provide a rider with a warning that the rider is approaching a boundary, whether actual or virtual. For example, warning signaler 367 can be activated when wireless receiver 360 receives a warning signal sent by wireless transmitter 370, which can be a remote control as illustrated by FIG. 4. In this case, a warning signal can be a different signal than a safety signal, but alternatively, could simply be the safety signal received at a lower signal strength as discussed below. Thus, it should be noted that a warning signal can alternatively be a safety signal received by wireless receiver 360 but at a lower signal strength, such as when wireless receiver 360 approaches wireless transmitter 370 such that the safety signal is received at a particular strength that is below a triggering strength level. Thus, when wireless receiver 360 approaches an actual boundary (see FIGS. 5 and 6, for example) and the safety signal is received at a signal strength below a triggering strength level, warning signaler 367 can warn the rider that the ride-on toy will shut down if the ride-on toy continues to approach the boundary. Once the ride-on toy is too close to the boundary, the signal strength of the safety signal received by wireless receiver 360 may exceed the determined triggering strength level and the ride-on toy will in fact shut down via activation of current regulator 340.

FIG. 4 illustrates another exemplary aspect of the present invention, in which a wireless transmitter can be a remote control 470. As illustrated, remote control 470 can be utilized to selectively send the wireless safety signal to wireless receiver 460. As further illustrated, remote control 470 can include a STOP button, which sends the wireless safety signal; and further, for example and not in limitation, can optionally include a RESET button for optionally resetting the safety system, a SLOW button for optionally increasing the resistance of current regulator 440, a FAST button for optionally decreasing the resistance of current regulator 440, and/or a WARN button for optionally issuing a warning signal. For example, and not in limitation, a supervising adult can manually initiate the present invention to WARN and/or STOP the ride-on toy if a child-operator is approaching an undesirable speed or location.

It should be noted that the optional reset mechanism illustrated herein can be incorporated in any embodiment described herein, and can be disposed on the ride-on toy, on a wireless transmitter, or anywhere else to the extent desired insofar as the same does not precludes its intended function.

FIG. 5 illustrates yet another exemplary aspect of the present invention, in which a wireless transmitter 570 can include an antennae 580 positioned to form a boundary 585. As illustrated, antennae 580 creates, in conjunction with wireless transmitter 570, a range 590 in which the safety signal is transmitted/receivable by wireless receiver 560, which is mounted on ride-on toy 595. For example, and not in limitation, the antennae 580 can be disposed above or underground, in whole or in part.

FIG. 6 illustrates still another exemplary aspect of the present invention, in which antennae 680 can be positioned such that boundary 685 is “closed” forming an enclosed area in which ride-on toy 695 can be operated.

It will be apparent to one of ordinary skill in the art that the manner of making and using the claimed invention has been adequately disclosed in the above-written description of the exemplary embodiments and aspects taken together with the drawings.

It should be noted that the present invention expressly contemplates application to any electric ride-on toy. Therefore, it should be understood that any description herein directed to any particular type of ride-on toy is merely for illustrative purposes, and is not to be construed as limiting the present invention to any particular type, size, shape, or material. Further, it should be noted that the present invention contemplates its various elements being in various configurations, with no limitation as to which elements are in combination with others, unless necessary to the function of the present invention or unless expressly stated herein as “necessary.”

Accordingly, the specification and drawings are to be regarded in an illustrative and enabling, rather than a restrictive, sense. Therefore, it will be understood that the above description of the embodiments of the present invention are susceptible to various modifications, changes, and adaptations, and the same are intended to be comprehended within the meaning and range of equivalents of the appended claims.

Therefore, we claim:

1. A safety system for an electric ride-on toy having an electric motor electrically connected to a battery providing electrical current to the electric motor, and an accelerator device electrically connected between the electric motor and the battery, the accelerator device being adapted to selectively deliver the electrical current from the battery to the electric motor, said safety system comprising:
a current regulator adapted to electrically connect between the battery and the electric motor; and
a control module, connected to said current regulator, and having an input device adapted to receive a safety command, said control module being adapted to activate said current regulator if the safety command is received by the input device;
wherein said control module activates said current regulator when the input device receives the safety command, and when activated, said current regulator reduces the electrical current provided from the accelerator device to the electric motor.

2. The safety system of claim 1, wherein said control module includes a variable resistor, and when activated, said current regulator reduces the electrical current at least in part.

3. The safety system of claim 1, wherein when activated, said current regulator reduces the electrical current in total.

4. The safety system of claim 3, further comprising:
a reset mechanism;
wherein, upon activation, said current regulator remains activated until said reset mechanism is triggered.

5. The safety system of claim 1, wherein the input device includes a wireless receiver, and said safety system further comprises:
a wireless transmitter adapted to send the safety command to said control module via the wireless receiver.

6. The safety system of claim 5, wherein said wireless transmitter, includes an antennae positioned to form a boundary, and transmits the safety signal along the boundary at a particular strength such that the wireless receiver receives the safety signal when said wireless receiver is within a particular distance from the boundary.

7. The safety system of claim 5, wherein said wireless transmitter, includes an antennae positioned to form a boundary, and transmits at least one of the safety signal and a warning signal along the boundary at a particular strength such that the wireless receiver receives the one of the safety signal and a warning signal when said wireless receiver is within a particular distance from the boundary.

8. The safety system of claim 6, wherein the antennae is positioned to form an enclosed area.

9. The safety system of claim 6, further comprising:
a reset mechanism;
wherein, upon activation, said current regulator remains activated until said reset mechanism is triggered.

10. A safety system for an electric ride-on toy having an electric motor electrically connected to a battery providing electrical current to the electric motor, and an accelerator device electrically connected between the electric motor and the battery, the accelerator device being adapted to deliver the electrical current from the battery to the electric motor, said safety system comprising:
a current regulator adapted to electrically connect between the battery and the electric motor;
wherein said current regulator reduces the electrical current provided from the accelerator device to the electric motor.
